(19) United States
(12) Patent Application Publication
(10) Pub. No.: US 2002/0027314 A1
(43) Pub. Date: Mar. 7, 2002

(54) Thermoplastic polymers with improved infrared reheat properties

(76) Inventors: Carl S. Nichols, Waxhaw, NC (US); Tony Clifford Moore, Charlotte, NC (US); Sharon Sue Griffith, Charlotte, NC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 09/973,520

(22) Filed: Oct. 9, 2001

Related U.S. Application Data
(62) Division of application No. 09/247,355, filed on Feb. 10, 1999.

(51) Int. Cl. B29C 35/08

(52) U.S. Cl. 264/492

(57) ABSTRACT

The invention relates to a method for using spinel pigments to increase the infrared heat-up rates of thermoplastic resins and specifically polyester bottle resins. In particular, the method comprises adding spinel pigments to polymerized resins to increase the reheat rates of the resulting polyester pre-forms. When uniformly distributed, these spinel pigments absorb applied energy and thereupon transfer the energy to the polyester.

### FIELD OF THE INVENTION

The invention relates to the manufacture of shaped thermoplastic items from polymer resins that respond to infrared radiation. In particular, the invention relates to a method of modifying the heat absorption properties of polyester to improve the reheat rates of polyester pre-forms, which promotes increased polyester-bottle production rates.

### BACKGROUND OF THE INVENTION

The present invention relates to the production of polyester bottles. The term “polyester” generally refers to the polycondensation products of dicarboxylic acids and dihydroxy alcohols, and is used in that sense herein. In conventional bottle manufacturing, virgin polyester is typically synthesized from ethylene glycol and either terephthalic acid or dimethyl terephthalate or from co-monomers that can include for example isophthalic acid, diethylene glycol (DEG), cyclohexane, and dimethanol, or others. The polyester is then made into pre-forms, which are subsequently reheated and blow-molded into polyester bottles. In typical processes, the pre-forms are heated using infrared (IR) radiation.

Reheat rates for polyester bottle pre-forms can be increased by dispersing energy absorbent particles throughout the polymer resins from which the pre-forms are manufactured. In particular, the presence of such absorbent particles within polyester pre-forms promotes the absorption of infrared radiation. More generally, energy absorbent particles can extend from simple organics, such as carbon black, to complex organics, such as anthraquinone, and to fine metal particles as well.

Each of these, however, offers particular disadvantages. Carbon black is messy to handle, hard to obtain and use in desired particle sizes, tends to agglomerate, and is hard to measure and mix in controlled amounts.

Fine metal particles are similarly difficult to measure and mix in controlled amounts, and likewise tend to vary too much in particle size for bottle manufacturing purposes. Large particles tend to produce haze and clarity problems in the resulting bottles, while small ones are difficult to handle, measure, and mix. Although metal particles can be generated in situ from catalysts and stabilizers (e.g., phosphoric acid stabilizer reducing antimony compounds to antimony metal), the results tend to be uneven and often unsatisfactory for reheat purposes. Alternatively, adjusting the catalysts and stabilizers for later reheat purpose tends to interfere with—and can detrimentally modify—their primary functions in the overall polymerization scheme.

In addition, lead and arsenic, which typically accompany the antimony catalyst, can affect the reheat characteristics of the resulting polymer resin. As the concentration of lead and arsenic varies, so too does the amount of precipitated antimony in the resulting polyester resins. This, in turn, leads to inconsistent pre-form reheat rates, which can adversely impact polyester bottle production.

Accordingly, a need exists for techniques for enhancing the pre-form reheating process, and that do not suffer from these disadvantages, and that can be used without modifying or jeopardizing the fundamental polymerization process.

### OBJECT AND SUMMARY OF THE INVENTION

It is therefore an object of the invention to improve the manufacturing of polyester bottles by favorably modifying the reheating properties of polyester bottle pre-forms.

In its broadest aspect, the invention comprises a method for using spinel pigments to increase the heat-up rates of thermoplastic resins. In particular, the method comprises adding spinel pigments to polymer resins to increase their reheat rates. When uniformly distributed, these spinel pigments absorb applied energy and thereupon transfer the energy to the polymer.

Using spinel pigments also avoids many of the problems associated with manipulating redox chemistry. For example, antimony may be used exclusively as a polymerization catalyst, and not as both a catalyst and a source of metal particles. In this way, the pre-form reheat rates become more consistent, and polyester bottle production is improved.

### BRIEF DESCRIPTION OF THE DRAWING

FIG. 1 is a plot of pre-form surface temperature in degrees centigrade plotted against overall oven power (expressed as a percentage of full power) for an infrared heating system.

### DETAILED DESCRIPTION OF THE INVENTION

The invention is a method for improving the reheat characteristics of thermoplastic resins that are responsive to IR radiation. More specifically, the invention uses spinel pigments, particularly calcinated compounds of copper, chromium, iron, and nickel, to modify the specific heat properties of polyester pre-forms.

In a first embodiment, polyester is synthesized either from ethylene glycol and terephthalic acid, or from ethylene glycol and dimethyl terephthalate. To achieve desired heat transfer characteristics in the resulting polyester, a spinel pigment is added to the reactants. Thereafter, a polyester bottle pre-form is injection molded from the spinel-containing polyester.

The preferred polyester, polyethylene terephthalate, may be synthesized from dimethyl terephthalate and ethylene glycol by a two-step ester exchange reaction. The initial esterification step, which forms low molecular weight polyester prepolymer, typically proceeds while the reactants are in solution. The subsequent melt polymerization step proceeds at a temperature above the melting point of the polyethylene terephthalate polymer. The reaction kinetics of the melt polymerization are improved by continually removing ethylene glycol.

It will be well-understood by those of ordinary skill in this art, of course, that polyester resins are frequently formed of copolymers that include either additional dicarboxylic acids (e.g. isophthalic acid) or other dihydroxy alcohols (e.g. diethylene glycol) or both. The invention described herein is just as suitable for use with such copolymers as it is with polyethylene terephthalate homopolymer. Accordingly, as used herein, phrases such as “synthesizing polyester from a dicarboxylic acid and a dihydroxy alcohol” will be understood to include the synthesis of copolymers that contain additional diacids or dialcohols or both.

Alternatively, in a preferred method of synthesizing polyethylene terephthalate, terephthalic acid is reacted with excess ethylene glycol to form an esterified intermediate. This is then polymerized to form a homopolymer by way of a condensation reaction. To promote the polymerization of the polyester, ethylene glycol should be continually removed to manipulate favorably the polymerization kinetics.

The synthesis of polyesters by applying either of these techniques is well-known to those of skill in the art, and is discussed—by way of example and not limitation—in Odian's Principles of Polymerization (Second Edition, 1981), which is published by Wiley-Interscience.

The diacid and dialcohol reactants may be obtained as purchased chemicals or, alternatively, the polyester can be obtained from resource recovery techniques. To the extent the invention is practiced using recycled polyester, the polyester must satisfy standards for packaging food products. Using only virgin polyester polymer does not generally create a purity problem.

One high-purity recycling method is fully described in the co-pending application “Food Quality Polyester Recycling,” Ser. No. 08/703,491, filed Aug. 27, 1996, and now U.S. Pat. No. ______, which is commonly assigned with this application. This effective polyester recycling technique includes first cleaning comminuted pieces of post-consumer polyester to remove surface contaminants. Then, the post-consumer polyester pieces are heated to form a polyester melt, which is then extruded and blended with a melt of virgin polyester prepolymer. The blended melt is then cooled such that the post-consumer polyester solidifies while the virgin polyester prepolymer remains as a prepolymer. The post-consumer polyester is pelletized and then polymerized in the solid state. Alternatively, a melt of post-consumer polyester and virgin polyester may first be pelletized, after which a blend of the respective pellets is polymerized in the solid state.

In a second embodiment, a polyester melt is obtained by heating either virgin or recycled polyester, or a combination of both. Likewise, to promote beneficial heat transfer properties in the resulting polyester product, a spinel pigment is added to the polyester melt. A polyester pre-form is then injection molded from the spinel-containing polyester. Whether polyester is synthesized from reactants or polyester is obtained in polymer form, the methods for practicing the invention are essentially the same regardless of the nature of the polyester starting materials.

The spinel pigments that are suitable in practicing the invention include both natural spinels and synthetic spinels. See Lewis, Hawley's Condensed Chemical Dictionary (12^{th} Edition), p. 1081. In a preferred embodiment, however, the spinel pigment is either copper chromite black spinel or chrome iron nickel black spinel. These preferred spinels are available as products designated “Black 1” and “Black 376,” respectively, from the Shepherd Color Company of Cincinnati, Ohio.

Including an amount of a spine pigment—especially copper chromite black spinel or chrome iron nickel black spinel—such that the resulting spinel-containing polyester has a spinel concentration of between about 10 parts per million (ppm) by weight and about 100 ppm by weight leads to a polyester pre-form having excellent reheat properties. A spinel concentration within the spinel-containing polyester of between about 20 ppm by weight and about 50 ppm by weight is more preferred, and a spinel concentration of about 50 ppm by weight is most preferred. The spinel pigments are easier to handle than carbon black or metal particles, have a more consistent size distribution, and can be measured more consistently than carbon black or metal particles.

Regardless of whether the starting materials are glycol and diacid reagents, or polyester polymer, the polyester bottle pre-forms may be injection molded directly from a spinel-containing polyester melt. Alternatively, such a spinel-containing polyester melt may be first crystallized to promote solid state polymerization or solidified to accommodate inventory requirements. In brief, the spinel-containing polyester melt may be solidified, and later heated just prior to the step of injection molding a polyester bottle pre-form.

In another aspect, the invention also includes blow molding a polyester pre-form to produce a polyester bottle. This may be accomplished by forcing air into a still hot polyester pre-form, or reheating a cooled polyester pre-form to facilitate the blow molding process. Again, the capability of cooling and reheating the pre-form facilitates inventory control and helps to overcome process limitations. The inclusion of the spinel pigments in the polyester pre-form increases reheat rates, a most desirable characteristic in the bottle manufacturing art. Furthermore, the spinel concentration within the polyester pre-form is easily controlled. Thus, steady-state manufacturing processes are more easily maintained; this improves bottle production throughput and product quality.

The infrared heating can be carried out in any appropriate or conventional fashion, including those techniques presently used to reheat pre-forms. The term “infrared” (IR) is generally used to refer to that portion of the electromagnetic spectrum between the visible and microwave ranges. Although the boundaries of the region are informal rather than absolute, the IR frequencies are usually considered to be from about 0.78 microns (μ) to about 300 μ (e.g., Lewis, supra, at page 635) or even to about 1000 μ (e.g., Sze, Physics of Semiconductor Devices, 2d Ed. (1981) at page 683). As known to those familiar with analytical spectroscopy, many of the functional groups present in organic molecules (including thermoplastic polymers) respond vibrationally to IR frequencies, thus—in the case of the pre-forms—generating the energy required for the reheating process.

When polyester is produced using glycols and acids, the spinel pigments may be added at various points in the polyester synthesis. For example, the spinel pigment may be added directly to these reactants in solution at the start of chemical synthesis. Alternatively, the spinel pigments may be added to be pre-polymer melt during esterification or to the polymer melt during condensation polymerization, or just prior to injection molding. The timing of the spinel pigment addition is largely one of convenience, however, given that the spinel pigments themselves do not react or otherwise interfere with the polyester polymerization. In other words, when the spinel pigment is added to the admixture is immaterial provided that the spinel pigments become fully distributed throughout the polyester resin. Thus, the heat transfer efficacy of the spinel pigments, especially that of the copper chromite black spinel and chrome iron nickel black spinel, is unaffected by the standard polyester synthesis, which may include solution esterification, melt polymerization, crystallization, and solid state polymerization. The presence of the well-distributed spinel pigments favorably increases the reheat rate of the polyester bottle pre-forms.

Practicing the invention as herein described will result in a polyester bottle pre-form having between about 10 ppm by weight and about 100 ppm by weight of spinel pigment. In preferred embodiments, such polyester pre-forms will contain between about 20 ppm by weight and about 50 ppm by weight of the spinel pigment, and in most preferred embodiments the polyester pre-form will contain about 50 ppm by weight of the spine pigment. As noted previously, copper chromite black spinel and chrome iron nickel black spinel are the most preferred spinel pigments. Finally, in practicing the invention, polyethylene terephthalate is the preferred polyester.

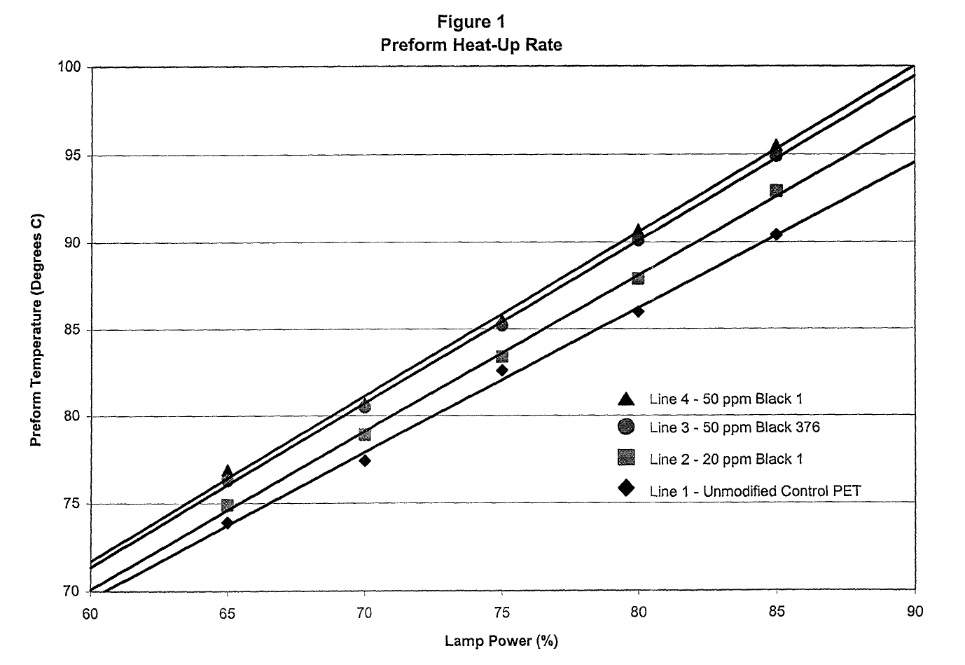

FIG. 1 illustrates some of the advantages of the invention in graphical fashion. FIG. 1 plots the pre-form surface temperature in degrees centigrade against the reheating lamp power for four (4) samples. Line 1 represents an unmodified control polyester. Lines 2-4 represent a polyester prepared at pilot scale using varying amounts (including zero) of reheat additives. The composition of Lines 3 and 4, which as FIG. 1 illustrates have the best reheat properties of the pilot polyesters, respectively include 50 ppm of the Shepherd's “Black 376” and “Black 1” pigments referred to above. Line 2 represents a composition with 20 ppm of the Shepherd's “Black 1”. Comparing lines 1-4 makes it evident that the use of the spinel pigment according to the present invention provides significantly improved reheat results.

It will be understood by those of skill in the art that the invention as herein disclosed is not limited to polyester homopolymers; the invention may also be practiced using polyester that is copolymerized or blended with another kind of polymer. Moreover, the specification has disclosed typical embodiments of the invention. In doing so, however, terms have been used only in a generic and descriptive sense, and not for purposes of limitation. The scope of the invention is set forth in the following claims.

That which is claimed is:

1. A method of increasing the reheat properties of thermoplastic polymers that are responsive to infrared radiation, the method comprising:
adding a spinel pigment to a thermoplastic polymer that is responsive to infrared radiation; and
heating the thermoplastic polymer and added spinel pigment with infrared radiation.

2. A method according to claim 1 wherein the spinel pigment is selected from the group consisting of natural spinel and synthetic spinels.

3. A method according to claim 1 wherein the heating step further comprises molding the heated thermoplastic polymer and spinel pigment.

4. A method of making a polyester bottle pre-form having favorable heat absorption properties, the method comprising:
synthesizing polyester from a dicarboxylic acid and a dihydroxy alcohol;
adding a spinel pigment to the reactants; and
thereafter injection molding a bottle pre-form from the spinel-containing polyester.

5. A method according to claim 4 comprising synthesizing a polyester copolymer that includes at least two dicarboxylic acids.

6. A method according to claim 5 comprising synthesizing the polyester copolymer from terephthalic acid and isophthalic acid.

7. A method according to claim 4 comprising synthesizing a polyester copolymer that includes at least two dihydroxy alcohols.

8. A method according to claim 7 comprising synthesizing the polyester copolymer from ethylene glycol and diethylene glycol.

9. A method according to claim 4 comprising synthesizing the polyester from
an acid selected from the group consisting of terephthalic acid, dimethyl terephthalate, isophthalic acid, dimethyl isophthalate, and combinations thereof; and
a dihydroxy alcohol selected from the group consisting of ethylene glycol, diethylene glycol, and combinations thereof.

10. A method for making a polyester pre-form according to claim 4 wherein the step of adding the spinel pigment comprises adding a spinel pigment to the reactants during esterification.

11. A method for making a polyester pre-form according to claim 4 wherein the step of adding the spinel pigment comprises adding a spinel pigment to the reactants during condensation polymerization.

12. A method for making a polyester pre-form according to claim 4 wherein the step of adding the spinel pigment comprises adding the spinel pigment to a polyester melt just prior to the injection molding step.

13. A method for making polyester pre-forms according to claim 4 wherein the step of adding the spinel pigment comprises adding a spinel pigment selected from the group consisting of natural spinel and synthetic spinels.

14. A method for making polyester pre-forms according to claim 4 wherein the step of adding the spinel pigment comprises adding a spinel pigment selected from the group consisting of copper chromite black spinel and chrome iron nickel black spinel.

15. A method for making a polyester pre-form according to claim 14 comprising adding the spinel pigment in an amount such that the spinel concentration of the resulting spinel-containing polyester is between about 10 ppm by weight and about 100 ppm by weight.

16. A method for making a polyester pre-form according to claim 15 comprising adding the spinel pigment in an amount such that the spinel concentration of the resulting spinel-containing polyester is about 50 ppm by weight.

17. A method for making a polyester pre-form according to claim 4 further comprising the step of heating the spinel-containing polyester to form a spinel-containing polyester melt prior to the step of injection molding the bottle pre-form from the spinel-containing polyester melt.

18. A method for making a polyester pre-form according to claim 17 further comprising:
solidifying the spinel-containing polyester melt; and
thereafter heating the spinel-containing polyester prior to the step of injection molding the bottle pre-form from the spinel-containing polyester.

19. A method according to claim 4 further comprising:
reheating the polyester pre-form with infrared radiation; and
thereafter blow molding the injection molded polyester pre-form to produce a polyester bottle.

20. A method of making a polyester bottle pre-form having favorable specific heat properties, the method comprising:
heating polyester to form a polyester melt;
adding a spinel pigment to the polyester melt; and
thereafter injection molding a polyester pre-form from the spinel-containing polyester.

21. A method for making a polyester pre-form according to claim 20 wherein the step of heating polyester comprises heating polyethylene terephthalate.

22. A method for making a polyester pre-form according to claim 20 wherein the step of adding the spinel pigment comprises adding a spinel pigment selected from the group consisting of natural spinel and synthetic spinels.

23. A method for making a polyester pre-form according to claim 20 wherein the step of adding the spinel pigment comprises adding a spinel pigment selected from the group consisting of copper chromite black spinel and chrome iron nickel black spinel.

24. A method for making a polyester pre-form according to claim 23 comprising adding the spinel pigment in an amount such that the spinel concentration of the resulting spinel-containing polyester is between about 10 ppm by weight and about 100 ppm by weight.

25. A method for making a polyester pre-form according to claim 23 comprising adding the spinel pigment in an amount such that the spinel concentration of the resulting spinel-containing polyester is about 50 ppm by weight.

26. A method for making a polyester pre-form according to claim 20 further comprising:
solidifying the spinel-containing polyester melt; and
thereafter reheating the spinel-containing polyester prior to the step of injection molding the polyester pre-form.

27. A method for making a polyester bottle according to claim 20 further comprising reheating the pre-form with infrared radiation and thereafter blow molding the polyester pre-form into a polyester bottle.

28. A method of making a polyester bottle comprising:
synthesizing polyester from a dicarboxylic acid and a dihydroxy alcohol;
adding a spinel pigment to the reactants to form a spinel-containing polyester; and
making a bottle from the spinel-containing polyester.

29. The method according to claim 28 wherein the step of making a spinel-containing polyester bottle comprises:
injection molding a bottle pre-form from the spinel-containing polyester; and thereafter
blow molding the spinel-containing polyester bottle pre-form to produce a polyester bottle.

30. A method according to claim 29 wherein the step of blow molding the bottle further comprises reheating the pre-form with infrared radiation.

31. A method of making a polyester bottle, the method comprising:
synthesizing a polyester prepolymer melt from a glycol and a dicarboxylic acid;
including a spinel pigment within the prepolymer melt;
crystallizing the polyester prepolymer;
polymerizing the crystallized polyester prepolymer in the solid state;
injection molding a pre-form from the resulting polyester; and
blow molding the polyester pre-form to produce a polyester bottle.

32. A method of making a polyester bottle according to claim 31 wherein the step of synthesizing a polyester prepolymer melt comprises synthesizing a polyethylene terephthalate prepolymer melt.

33. A method according to claim 31 further comprising the step of reheating the pre-form with infrared radiation prior to the step of blow molding the pre-form into a bottle.

34. A method of making a polyester bottle according to claim 31 wherein the step of including the spinel pigment comprises adding a spinel pigment to the glycol and acid reactants.

35. A method of making a polyester bottle according to claim 31 wherein the step of including the spinel pigment comprises adding a spinel pigment to the prepolymer melt.

36. A method according to claim 35 comprising adding the spinel pigment just prior to the step of injection molding the pre-form.

37. A method for making a polyester pre-form according to claim 31 wherein the step of adding the spinel pigment comprises adding a spinel pigment selected from the group consisting of copper chromite black spinel and chrome iron nickel black spinel.

38. A method for making a polyester pre-form according to claim 37 comprising adding the spinel pigment in an amount such that the spinel concentration of the resulting spinel-containing polyester is between about 10 ppm by weight and about 100 ppm by weight.

39. A method for making a polyester pre-form according to claim 38 comprising adding the spinel pigment in an amount such that the spinel concentration of the resulting spinel-containing polyester is about 50 ppm by weight.

40. A method of making a polyester bottle pre-form having improved reheat characteristics, the method comprising:
injection molding a pre-form from a polyester containing about 10 to 100 ppm by weight of spinel pigment selected from the group consisting of copper chromite black spinel and chrome iron nickel black spinel;
reheating the polyester pre-form; and
blow molding the polyester pre-form to form a polyester bottle.

41. A method according to claim 40 wherein the reheating step comprises reheating the pre-form with infrared radiation.

42. A method for making a polyester pre-form according to claim 40 wherein the step of injection molding the pre-form comprises injection molding a pre-form from a polyester containing about 50 ppm by weight of the spinel pigment.

43. A method for making a polyester pre-form according to claim 40 wherein the step of injection molding the pre-form from polyester comprises injection molding the pre-form from polyethylene terephthalate.

44. A polyester bottle pre-form comprising between about 10 ppm by weight and about 100 ppm by weight of a spinel pigment selected from the group consisting of copper chromite black spinel and chrome iron nickel black spinel.

45. The polyester pre-form according to claim 44 wherein said spinel pigment is present between about 20 ppm by weight and about 50 ppm by weight.

46. The polyester pre-form according to claim 45 wherein said spinel pigment is present at about 50 ppm by weight.

47. The polyester pre-form according to claim 44 comprising polyethylene terephthalate.

48. The polyester pre-form according to claim 47 wherein said spinel pigment is present between about 20 ppm by weight and about 50 ppm by weight.

49. The polyester pre-form according to claim 48 wherein said spinel pigment is present at about 50 ppm by weight.
